(19) United States
(12) Patent Application Publication
(10) Pub. No.: US 2026/0138639 A1
(43) Pub. Date: May 21, 2026

(54) CONTROL DEVICE, CONTROL METHOD, AND STORAGE MEDIUM

(71) Applicant: HONDA MOTOR CO., LTD., Tokyo (JP)

(72) Inventors: Yuki HARA, Tokyo (JP); Hideki NAGATOMO, Tokyo (JP)

(73) Assignee: HONDA MOTOR CO., LTD., Tokyo (JP)

(21) Appl. No.: 19/355,496

(22) Filed: Oct. 10, 2025

(30) Foreign Application Priority Data
Oct. 11, 2024 (JP) 2024-178557

(51) Int. Cl. B60W 60/00; B60W 30/06; G07C 5/04

(52) U.S. Cl. CPC B60W 60/001; B60W 30/06; G07C 5/04; B60W 2552/10

(57) ABSTRACT

A control device for controlling a vehicle, includes: a travel control unit configured to perform, based on travel history information including travel route information indicating a travel route during first travel to a current position of the vehicle, second travel for causing the vehicle to move along the travel route from the current position to a movement completion point on the travel route, the travel history information being stored in a storage unit; and a setting unit configured to set, before the second travel, a point on the travel route satisfying a predetermined condition as the movement completion point. The travel control unit performs the second travel to the movement completion point set by the setting unit, and ends the second travel in response to the vehicle reaching the movement completion point.

This application is based upon and claims the benefit of priority from prior Japanese patent application No. 2024-178557, filed on Oct. 11, 2024, the entire contents of which are incorporated herein by reference.

### TECHNICAL FIELD

The present disclosure relates to a control device, a control method, and a storage medium storing a control program.

### BACKGROUND ART

In recent years, improvements in traffic safety have been required to enable inclusion, safety, toughness, and sustainability of urban and human residents. From a viewpoint of improving the traffic safety, for example, developments of a driving assistance technique and an autonomous driving technique for vehicles have been advanced.

As an example of the driving assistance technique, JP2018-203214A discloses a technique in which a peripheral image generated based on an imaging result of an imaging unit provided in a vehicle is displayed on a touch panel, a first symbol representing a parking region where the vehicle can be parked is displayed on the peripheral image, and when a position corresponding to the first symbol is touched, parking in the parking region represented by the first symbol is assisted.

### SUMMARY OF INVENTION

There is room for improvement from a viewpoint of improving convenience of a user.

Aspects of the present disclosure relate to providing a control device, a control method, and a storage medium storing a control program capable of improving convenience of a user.

According to an aspect of the present disclosure, there is provided a control device for controlling a vehicle, including:
a travel control unit configured to perform, based on travel history information including travel route information indicating a travel route during first travel to a current position of the vehicle, second travel for causing the vehicle to move along the travel route from the current position to a movement completion point on the travel route, the travel history information being stored in a storage unit; and
a setting unit configured to set, before the second travel, a point on the travel route satisfying a predetermined condition as the movement completion point, in which
the travel control unit performs the second travel to the movement completion point set by the setting unit, and ends the second travel in response to the vehicle reaching the movement completion point.

According to another aspect of the present disclosure, there is provided a control method including:
performing, by a computer that controls a vehicle, based on travel history information including travel route information indicating a travel route during first travel to a current position of the vehicle, second travel for causing the vehicle to move along the travel route from the current position to a movement completion point on the travel route, the travel history information being stored in a storage unit; and
setting, by the computer, before the second travel, a point on the travel route satisfying a predetermined condition as the movement completion point, in which
in the processing of causing the vehicle to move along the travel route, the second travel to the set movement completion point is performed, and the second travel is ended in response to the vehicle reaching the movement completion point.

According to another aspect of the present disclosure, there is provided a non-transitory computer-readable storage medium storing a control program causing a computer that controls a vehicle to perform a process including:
performing, based on travel history information including travel route information indicating a travel route during first travel to a current position of the vehicle, second travel for causing the vehicle to move along the travel route from the current position to a movement completion point on the travel route, the travel history information being stored in a storage unit; and
setting, before the second travel, a point on the travel route satisfying a predetermined condition as the movement completion point, in which
in the causing of the vehicle to move along the travel route, the second travel to the set movement completion point is performed, and the second travel is ended in response to the vehicle reaching the movement completion point.

According to the present disclosure, it is possible to provide a control device, a control method, and a storage medium storing a control program capable of improving convenience of a user.

### BRIEF DESCRIPTION OF DRAWINGS

Exemplary embodiment(s) of the present invention will be described in detail based on the following figures, wherein:

FIG. 1 is a block diagram showing a schematic configuration of a vehicle 1 including a control device 30 that is an embodiment of a control device of the present disclosure;

FIG. 2 is a diagram showing an example of travel history information 200 stored in a storage unit 35;

FIG. 3 is a diagram showing a first example of a movement completion point EP set by a setting unit 31;

FIG. 4 is a diagram showing a second example of the movement completion point EP set by the setting unit 31;

FIG. 5 is a diagram showing a third example of the movement completion point EP set by the setting unit 31;

FIG. 6 is a diagram showing a fourth example of the movement completion point EP set by the setting unit 31;

FIG. 7 is a diagram showing a fifth example of the movement completion point EP set by the setting unit 31;

FIG. 8 is a flowchart (Part 1) showing an example of processing performed by the control device 30; and

FIG. 9 is a flowchart (Part 2) showing an example of the processing performed by the control device 30.

### DESCRIPTION OF EMBODIMENTS

Hereinafter, an embodiment of a control device, a control method, and a storage medium storing a control program of the present disclosure will be described with reference to the drawings. The drawings are viewed in directions of reference numerals. The following embodiment does not limit the present disclosure, and not all of elements described in the following embodiment are necessary to the present disclosure. Hereinafter, the same or similar elements are denoted by the same or similar reference signs, and the description thereof may be omitted or simplified.

### 1. Vehicle

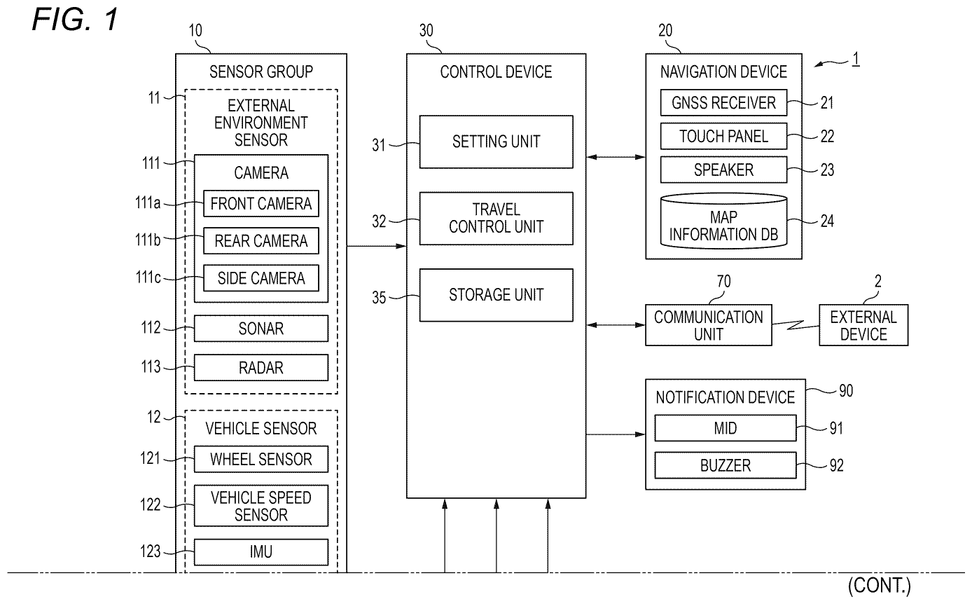

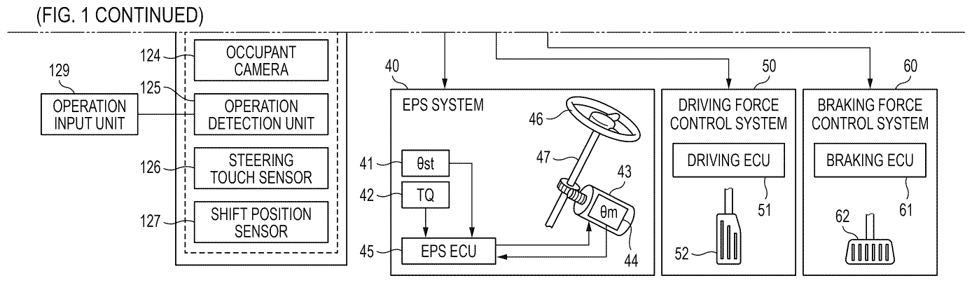

A vehicle 1 according to the present embodiment shown in FIG. 1 is an automobile including a drive source (not shown), and wheels (not shown) including drive wheels driven by power of the drive source and steered wheels that are steerable. As an example, the vehicle 1 may be a four-wheeled automobile including a pair of left and right front wheels and a pair of left and right rear wheels.

The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or the four wheels including the pair of left and right front wheels and the pair of left and right rear wheels. The front wheels and the rear wheels of the vehicle 1 may all be steerable steered wheels, or the front wheels or the rear wheels may be steerable steered wheels.

The vehicle 1 includes a sensor group 10, a navigation device 20, a control device 30, an electric power steering (EPS) system 40, a driving force control system 50, a braking force control system 60, a communication unit 70, and a notification device 90.

The sensor group 10 includes an external environment sensor 11 that acquires external environment information for recognizing a periphery (in other words, surroundings) of the vehicle 1, and a vehicle sensor 12 that acquires information on the vehicle 1 (hereinafter, also referred to as “vehicle information”). The information acquired by each sensor in the sensor group 10 is output to the control device 30, and is used for control of the vehicle 1 (hereinafter, also referred to as “vehicle control”) performed by the control device 30.

The external environment sensor 11 includes, for example, cameras 111, a sonar 112, and a radar 113. The cameras 111 image the periphery of the vehicle 1 including a front side of the vehicle 1, and output image data of an obtained peripheral image to the control device 30. Such image data is an example of the external environment information. As the camera 111, for example, a digital camera using an imaging element such as a charge coupled device (CCD) or a complementary metal oxide semiconductor (CMOS) can be adopted.

More specifically, the cameras 111 include, for example, a front camera 111a, a rear camera 111b, and side cameras 111c. The front camera 111a is provided, for example, on an upper portion of a front window or a front grille (not shown) of the vehicle 1, and images a scene in front of the vehicle 1. The rear camera 111b is provided, for example, near a license plate (in other words, an automobile registration number mark) attached to a rear portion of the vehicle 1, and images a scene behind the vehicle 1. The side cameras 111c are provided, for example, on left and right side mirrors (not shown), and image scenes on lateral sides (that is, left and right sides) of the vehicle 1.

The sonar 112 emits sound waves to the periphery of the vehicle 1 (for example, the front side, the rear side, and the lateral sides of the vehicle 1), and receives reflected sounds from an object present in the periphery of the vehicle 1, thereby detecting a distance to the object from the vehicle 1, an azimuth of the object, and the like, and outputs the detection result to the control device 30. The detection result of the sonar 112 is another example of the external environment information.

The radar 113 emits radio waves to the periphery of the vehicle 1 including the front side of the vehicle 1, and receives reflected waves from an object present in the periphery of the vehicle 1, thereby detecting a distance to the object, a direction of the object, and the like. As the radar 113, for example, a millimeter wave radar can be adopted. The detection result of the radar 113 is another example of the external environment information.

The external environment sensor 11 may include light detection and ranging (LiDAR) instead of or in addition to the sonar 112 and the radar 113. In this case, the LiDAR emits laser light to the periphery of the vehicle 1 including the front side of the vehicle 1, and receives reflected light from an object present in the periphery of the vehicle 1, thereby detecting a distance to the object from the vehicle 1, an azimuth of the object, and the like.

The vehicle sensor 12 includes, for example, a wheel sensor 121, a vehicle speed sensor 122, an inertial measurement unit (IMU) 123, an occupant camera 124, an operation detection unit 125, a steering touch sensor 126, and a shift position sensor 127.

The wheel sensor 121 detects a rotation angle of one or more wheels among the wheels of the vehicle 1. As an example, the wheel sensor 121 detects rotation angles of the left rear wheel and the right rear wheel. As the wheel sensor 121, for example, an angle sensor or a displacement sensor can be adopted.

The vehicle speed sensor 122 detects a vehicle speed VP that is a travel speed of the vehicle 1 (in other words, a movement speed of a vehicle body). For example, the vehicle speed sensor 122 detects the vehicle speed VP based on a rotation speed of a counter shaft (not shown) provided in the vehicle 1.

The inertial measurement unit 123 detects angular velocities of the vehicle 1 in a pitch direction, a roll direction, and a yaw direction, and accelerations of the vehicle 1 in a front-rear direction, a left-right direction, and an upper-lower direction. The vehicle sensor 12 may include, instead of the inertial measurement unit 123, an acceleration sensor that detects an acceleration of the vehicle 1 in a predetermined direction and a gyro sensor that detects an angular velocity of the vehicle 1 in a predetermined direction.

The occupant camera 124 is a digital camera that images an interior of the vehicle 1 and outputs image data of an obtained interior image to the control device 30. For example, the occupant camera 124 can be a so-called “driver monitor camera” provided to be able to image a head of an occupant seated in a driver seat of the vehicle 1 (for example, a user driving the vehicle 1, hereinafter simply referred to as “user”) from the front. As the occupant camera 124, a digital camera using an imaging element such as the CCD or the CMOS can be adopted, similarly to the camera 111.

The operation detection unit 125 detects an operation performed by using an operation input unit 129 that is operable by the user. The operation input unit 129 may include, for example, a switch or a button that receives a reverse assist operation request to be described later.

The steering touch sensor 126 detects whether a steering 46 of the vehicle 1 is gripped appropriately. For example, the steering touch sensor 126 is implemented by a capacitance sensor or the like. In this case, the capacitance sensor is provided at a portion touched by the user when the steering 46 is gripped appropriately.

The shift position sensor 127 detects, for example, whether a shift position of a shift lever (not shown) provided in the vehicle 1 is any one of “P (parking)”, “R (reverse)”, “N (neutral)”, and “D (drive)”. When the vehicle 1 may take another shift position (for example, “B (brake)”) other than the “P”, the “R”, the “N”, and the “D”, the shift position sensor 127 may also detect whether the shift position is the other shift position.

The navigation device 20 includes, for example, a global navigation satellite system (GNSS) receiver 21, a touch panel 22, and a speaker 23. The navigation device 20 includes a storage unit (not shown) implemented by a flash memory or the like. The storage unit of the navigation device 20 stores a map information database (DB) 24 and the like.

The map information database 24 includes road network information. The road network information is information representing roads based on a combination of nodes and links connecting the nodes (also referred to as “paths”). Each of the nodes in the road network information represents, for example, a feature of the corresponding road such as an intersection, a corner, or a dead end. In the road network information, for each of the nodes, for example, information indicating a location corresponding to the node (for example, coordinates that enable specifying of one point on a map such as a latitude and a longitude) is set. Further, in the road network information, for each of the links, information indicating nodes at both ends of the link, a road corresponding to the link, a link length, a lane number, a travel direction, a road type, and the like is set.

The GNSS receiver 21 specifies a current position of the vehicle 1 (for example, a latitude and a longitude of a location where the vehicle 1 is located) based on a signal received from a GNSS satellite. For example, the navigation device 20 may acquire a detection result of the vehicle sensor 12 (for example, the wheel sensor 121 or the vehicle speed sensor 122) via the control device 30, and specify or complement the current position of the vehicle 1 by an inertial navigation system (INS) using a detection value of the vehicle sensor 12.

For example, the touch panel 22 is implemented by combining a display device such as a liquid crystal display or an organic light emitting diode (OLED) with a pointing device (for example, a touch pad). The speaker 23 is configured to output sound to the occupant of the vehicle 1 including the user. The touch panel 22 is an example of a notification unit capable of issuing a notification to the user. The speaker 23 is another example of the notification unit capable of issuing a notification to the user.

For example, the navigation device 20 searches for, by referring to the map information database 24, a route from the current position of the vehicle 1 to a destination set by the user using the touch panel 22. Then, the navigation device 20 performs route guidance using the touch panel 22 and the speaker 23 based on the found route.

Further, the navigation device 20 may cause the touch panel 22 to perform a predetermined display according to an instruction from the control device 30. Further, the navigation device 20 may output predetermined information (for example, information indicating an operation received via the touch panel 22) to the control device 30. For example, the navigation device 20 may cause, according to an instruction from the control device 30, the touch panel 22 to display a button for receiving a reverse assist operation request to be described later.

The control device 30 is an example of the control device according to the present disclosure and is a computer that integrally controls the entire vehicle 1. For example, the control device 30 includes, for example, a processor (not shown) that performs various calculations, a storage unit 35 including a non-transitory storage medium that stores various types of information (for example, programs and various types of data), and an input and output unit (not shown) as an interface that controls input and output of data between the inside and the outside of the control device 30.

The control device 30 includes, for example, a setting unit 31 and a travel control unit 32 as functional units implemented by the processor executing the programs stored in the storage unit 35. These functional units will be described later, and thus the description thereof will be omitted here. For example, the control device 30 is implemented by one electronic control unit (ECU) or by a plurality of ECUs working in cooperation with each other.

The EPS system 40 includes, for example, a steering angle sensor 41, a torque sensor 42, an EPS motor 43, a resolver 44, and an EPS ECU 45.

The steering angle sensor 41 detects a steering angle θst of the steering 46 and outputs information indicating the detected steering angle θst to the EPS ECU 45. The torque sensor 42 detects a steering torque TQ, which is a torque applied to the steering 46 of the vehicle 1, and outputs information indicating the detected steering torque TQ to the EPS ECU 45.

The EPS motor 43 assists the user in operating the steering 46 by applying, according to an instruction from the EPS ECU 45, a driving force or a reaction force to a steering column 47 coupled to the steering 46. The resolver 44 detects a rotation angle θm of the EPS motor 43 and outputs information indicating the detected rotation angle θm to the EPS ECU 45.

The EPS ECU 45 is a computer which includes, for example, a processor that performs various calculations, a storage unit including a non-transitory storage medium that stores various types of information, and an input and output unit that controls input and output of data between the inside and the outside of the EPS ECU 45 (none is shown), and controls the EPS system 40 (for example, the EPS motor 43). The EPS ECU 45 is implemented by one or two or more ECUs. For example, the EPS ECU 45 controls the EPS system 40 (for example, the EPS motor 43) based on the steering angle θst detected by the steering angle sensor 41, the steering torque TQ detected by the torque sensor 42, the rotation angle θm detected by the resolver 44, and the like. The EPS ECU 45 can also control the EPS system 40 according to an instruction from the control device 30.

The EPS system 40 (for example, the EPS ECU 45) may output, to the control device 30, information indicating the steering angle θst detected by the steering angle sensor 41, the steering torque TQ detected by the torque sensor 42, the rotation angle θm detected by the resolver 44, and the like. Further, the EPS system 40 (for example, the EPS ECU 45) may output information indicating a steering speed ω of the steering 46 to the control device 30. In this case, the steering speed ω is obtained by, for example, differentiating the steering angle θst with respect to time.

The driving force control system 50 includes a driving ECU 51, and is configured to control a driving force of the vehicle 1. The driving ECU 51 is a computer that includes, for example, a processor that performs various calculations, a storage unit including a non-transitory storage medium that stores various types of information, and an input and output unit that controls input and output of data between the inside and the outside of the driving ECU 51 (none is shown), and controls the driving force control system 50. The driving ECU 51 is implemented by one or more ECUs. For example, the driving ECU 51 controls power output from the drive source of the vehicle 1, based on an operation on an accelerator pedal 52 provided in the vehicle 1. The driving ECU 51 can also control the driving force control system 50 (for example, the drive source) according to an instruction from the control device 30.

The braking force control system 60 includes a braking ECU 61, and is configured to control a braking force of the vehicle 1. The braking ECU 61 is a computer that includes, for example, a processor that performs various calculations, a storage unit including a non-transitory storage medium that stores various types of information, and an input and output unit that controls input and output of data between the inside and the outside of the braking ECU 61 (none is shown), and controls the braking force control system 60. The braking ECU 61 is implemented by one or more ECUs. For example, the braking ECU 61 controls the braking force of the vehicle 1 by controlling a brake device (not shown) provided in the vehicle 1, based on an operation on a brake pedal 62 provided in the vehicle 1. Here, the brake device includes, for example, a brake caliper, a cylinder that transmits a hydraulic pressure to the brake caliper, and an electric motor that generates a hydraulic pressure in the cylinder. The braking ECU 61 controls an electric motor of the brake device such that a braking force corresponding to the operation on the brake pedal 62 is generated. The braking ECU 61 can also control the braking force control system 60 (for example, the brake device) according to an instruction from the control device 30.

The communication unit 70 is a communication interface that communicates with an external device 2 under control of the control device 30. That is, the control device 30 may communicate with the external device 2 via the communication unit 70. Examples of the external device 2 include a terminal device (for example, a smartphone) of the user and a server device managed by a manufacturer of the vehicle 1. For example, a mobile communication network such as a cellular line, WI-FI (registered trademark), or Bluetooth (registered trademark) can be used for the communication between the vehicle 1 and the external device 2.

The notification device 90 is a device that issues a notification (for example, an alarm) to the user under the control of the control device 30. The notification device 90 includes, for example, a multi-information display (MID) 91 and a buzzer 92.

The MID 91 is implemented by a display device such as a liquid crystal display or an OLED, and is provided at a position that can be visually recognized by the user (for example, in a meter panel of the vehicle 1). For example, the MID 91 displays a predetermined image according to an instruction from the control device 30. The MID 91 is another example of the notification unit capable of issuing a notification to the user. The MID 91 may be integrated with the touch panel 22 described above.

The buzzer 92 is configured to output a predetermined sound. For example, the buzzer 92 outputs a predetermined alarm sound or a sound effect according to an instruction from the control device 30. The buzzer 92 is another example of the notification unit capable of issuing a notification to the user. The buzzer 92 may be integrated with the speaker 23 described above.

### 2. Control Device

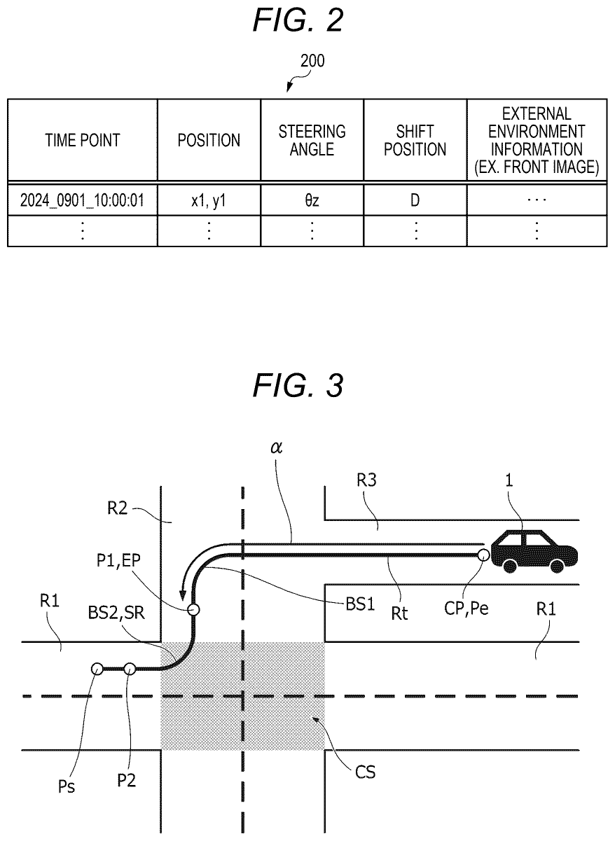

Next, the control device 30 will be described in more detail. First, an example of the information stored in the storage unit 35 will be described with reference to FIG. 2.

### 2-1. Travel History Information Stored in Storage Unit

The storage unit 35 stores, for example, travel history information 200 shown in FIG. 2. As shown in FIG. 2, the travel history information 200 includes, for example, information indicating the position of the vehicle 1, the steering angle θst, and the shift position (for example, “P”, “R”, “N”, or “D”) at each time point. The information indicating the steering angle θst in the travel history information 200 is an example of “control information” in the present disclosure. The information indicating the shift position in the travel history information 200 is another example of the “control information” in the present disclosure.

For example, when the vehicle 1 is manually driven, the control device 30 acquires information indicating the latitude and longitude of the point where the vehicle 1 is located, which is specified by the navigation device 20 (for example, the GNSS receiver 21), the information indicating the steering angle θst detected by the EPS system 40 (for example, the steering angle sensor 41), and the information indicating the shift position detected by the shift position sensor 127, at a predetermined cycle (for example, every 10 [ms]). Then, the control device 30 stores the acquired information indicating these into the storage unit 35 in association with information indicating a time point at the time of acquisition. Accordingly, the travel history information 200 is stored which includes information in which the information indicating the position of the vehicle 1, the information indicating the steering angle θst, and the information indicating the shift position at the same time point during travel based on manual driving are associated with one another.

The travel history information 200 may include other information. For example, as shown in FIG. 2, the travel history information 200 may further include the external environment information at each time point. As an example, the travel history information 200 may include information indicating a front image at each time point as the external environment information. In this case, when the vehicle 1 is manually driven, the control device 30 may acquire the information indicating the latitude and longitude of the point where the vehicle 1 is located, which is specified by the navigation device 20, the information indicating the steering angle θst detected by the EPS system 40, the information indicating the shift position detected by the shift position sensor 127, and the information indicating the front image captured by the front camera 111a at a predetermined cycle, and store the acquired information indicating these into the storage unit 35 in association with the information indicating the time point at the time of acquisition. In this way, the travel history information 200 including information in which the information indicating the position of the vehicle 1, the information indicating the steering angle θst, the information indicating the shift position, and the external environment information at the same time point during travel based on manual driving are associated with one another can be stored into the storage unit 35.

The travel history information 200 including the information indicating the position of the vehicle 1 at each time point can also be said to be information indicating a temporal transition of the position of the vehicle 1. The temporal transition of the position of the vehicle 1 represents a travel route on which the vehicle 1 has traveled. Therefore, the travel history information 200 includes travel route information indicating a travel route along which the vehicle 1 has traveled. As described above, when the travel history information 200 is stored based on the fact that the vehicle 1 is traveling by manual driving, the travel history information 200 includes the travel route information indicating a travel route (hereinafter also referred to as “travel route Rt”) along which the vehicle 1 has traveled based on the manual driving.

In the travel history information 200, the information indicating the steering angle θst associated with the information indicating each position of the vehicle 1 represents the steering angle θst when the vehicle 1 is at the position, that is, an operation state of the steering 46. Therefore, the travel history information 200 may represent the operation state of the steering 46 when the vehicle 1 travels on the travel route Rt.

Further, in the travel history information 200, the information indicating the shift position associated with the information indicating each position of the vehicle 1 represents the shift position when the vehicle 1 is at the position, that is, an operation state of the shift lever. Therefore, the travel history information 200 may represent the operation state of the shift lever when the vehicle 1 travels on the travel route Rt.

In the present embodiment, the control device 30 stores, into the storage unit 35, the travel history information 200 indicating the travel route Rt of a predetermined distance (for example, 200 [m]) immediately before the vehicle 1 reaches the current position. In other words, the control device 30 deletes, from the storage unit 35, information on a portion of the travel route that is outside the predetermined distance due to the travel of the vehicle 1. Accordingly, a storage area of the storage unit 35 required to store the travel history information 200 can be reduced.

In the following description, an end point (hereinafter, also referred to as “end point Pe”) of the travel route Rt is a point corresponding to a position of the vehicle 1 that is latest in time series in the travel history information 200 stored in the storage unit 35. That is, in a situation where the travel history information 200 is updated, the current position of the vehicle 1 may be the end point Pe. Based on the fact that the travel history information 200 is updated when the vehicle 1 is manually driven, the end point Pe can also be said to be a point at which the vehicle 1 has arrived last by the manual driving.

In the following description, a start point (hereinafter, also referred to as “start point Ps”) of the travel route Rt is a point on an opposite side of the end point Pe (that is, the current position of the vehicle 1) in the travel route Rt, and is a point corresponding to a position of the vehicle 1 that is oldest in time series in the travel history information 200 stored in the storage unit 35. That is, a point separated from the current position of the vehicle 1 by the predetermined distance along the travel route Rt may be the start point Ps.

In the present embodiment, the control device 30 includes the storage unit 35 that stores the travel history information 200, but the present disclosure is not limited thereto. That is, the storage unit 35 may be provided outside the control device 30 in a state of being accessible by the control device 30.

### 2-2. Processing Performed by Control Device

The control device 30 is configured to perform reverse assist by a function of the travel control unit 32 to be described later. Here, the reverse assist is a vehicle control for moving (for example, reversing) the vehicle 1 along the travel route Rt from the current position of the vehicle 1 to the movement completion point EP on the travel route Rt indicated by the travel route information contained in the travel history information 200. The reverse assist may be used, for example, in a situation where the vehicle 1 is forced to move backward because the vehicle 1 enters a dead end or cannot pass by an oncoming vehicle.

Hereinafter, travel of the vehicle 1 based on the manual driving of the user is also referred to as “manual driving travel”, and travel of the vehicle 1 based on the reverse assist is also referred to as “reverse assist travel”. The manual driving travel is an example of first travel in the present disclosure, and the reverse assist travel is an example of second travel in the present disclosure.

During the manual driving travel, the user steers the vehicle 1 using the steering 46. Meanwhile, during the reverse assist travel, the control device 30 automatically controls the steering of the vehicle 1. Therefore, by using the reverse assist, the user can return the vehicle 1 to the previous movement completion point EP without operating the steering 46 by himself/herself. Accordingly, time and effort for the user to return the vehicle 1 to the movement completion point EP can be reduced, and the convenience of the user can be improved.

For example, the control device 30 performs the reverse assist in response to receiving a predetermined reverse assist operation request (hereinafter, also referred to as “RA operation request”). The RA operation request can be, for example, an operation on a predetermined operator provided in the operation input unit 129 or an operation of tapping a predetermined button displayed on the touch panel 22. The control device 30 may stop the reverse assist travel when a predetermined stop operation is performed during the reverse assist travel. Similarly to the RA operation request, the stop operation can be, for example, an operation on a predetermined operator provided in the operation input unit 129 or an operation of tapping a predetermined button displayed on the touch panel 22.

The setting unit 31 of the control device 30 sets a point satisfying a predetermined condition on the travel route Rt as the movement completion point EP before the reverse assist travel (for example, in response there being the RA operation request). Specifically, the setting unit 31 sets, based on the travel history information 200 stored in the storage unit 35, a point satisfying the predetermined condition on the travel route Rt as the movement completion point EP. When setting the movement completion point EP, the setting unit 31 may further refer to the map information database 24 stored in the navigation device 20 or the like to determine an attribute of each point on the travel route Rt.

In this way, the control device 30 (for example, the setting unit 31) automatically sets the movement completion point EP, thus time and effort for the user to set the movement completion point EP is reduced and the convenience of the user can be improved. An example of setting the movement completion point EP by the setting unit 31 will be described later.

When the movement completion point EP is set by the setting unit 31, the travel control unit 32 performs reverse assist travel from the current position of the vehicle 1 to the movement completion point EP. Specifically, based on the travel history information 200 stored in the storage unit 35, the travel control unit 32 moves (for example, reverses) the vehicle 1 from the current position of the vehicle 1 to the movement completion point EP set by the setting unit 31 along the travel route Rt. At this time, the travel control unit 32 may control the steering of the vehicle 1 via the EPS system 40 such that the vehicle 1 travels while tracing a portion of the travel route Rt from a point corresponding to the current position of the vehicle 1 to the movement completion point EP. At this time, the travel control unit 32 may control the driving force of the vehicle 1 via the driving force control system 50, or may control the braking force of the vehicle 1 via the braking force control system 60. However, the present disclosure is not limited thereto, and the driving force or the braking force of the vehicle 1 may be adjusted by the user via the accelerator pedal 52 or the brake pedal 62, for example. In other words, the control device 30 may control only the steering of the vehicle 1.

As described above, the travel history information 200 may include the information indicating the steering angle θst when the vehicle 1 travels on the travel route Rt. Therefore, during the reverse assist travel, the travel control unit 32 may control the steering of the vehicle 1 while referring to the information indicating the steering angle θst contained in the travel history information 200. In this way, since it is not necessary to re-derive, during the reverse assist travel, the steering angle θst required by the vehicle 1 to travel along the travel route Rt, the reverse assist travel can be appropriately performed by simple processing.

Then, the travel control unit 32 ends the reverse assist travel in response to the vehicle 1 reaching the movement completion point EP set by the setting unit 31.

The travel control unit 32 may start the reverse assist travel in response to a predetermined start operation performed by the user after the movement completion point EP is set by the setting unit 31. In this way, it is possible to prevent the reverse assist travel from being started at a timing not intended by the user.

Before the reverse assist travel, the control device 30 preferably notifies the user of the set movement completion point EP. As an example, the control device 30 can notify the user of the set movement completion point EP by displaying, on the touch panel 22, an overhead image in which the travel route Rt is drawn from an overhead viewpoint and displaying a predetermined icon or the like at a location corresponding to the movement completion point EP in the overhead image.

Further, during the reverse assist travel, the control device 30 may notify the user as to where on the travel route Rt the vehicle 1 is traveling, by performing display such that the icon representing the vehicle 1 moves toward the movement completion point EP on the travel route Rt in the overhead image based on the vehicle 1 at that time.

Next, the example of setting the movement completion point EP by the setting unit 31 will be described.

### First Example of Movement Completion Point

As shown in FIG. 3, for example, it is assumed that the vehicle 1 turns left at an intersection (here, a crossroad) CS between a first road R1 and a second road R2, and then enters a third road R3 connected to the second road R2. In this case, as shown in FIG. 3, the travel route Rt may include an inflection section BS1 and an inflection section BS2 as sections (hereinafter also referred to as “inflection sections BS”) in which a direction of the vehicle 1 changes by a predetermined angle (for example, 90 degrees) or more. Here, the inflection section BS can be, for example, a section in which the direction of the vehicle 1 changes by a predetermined angle or more while the vehicle 1 moves by a predetermined distance (for example, 5 [m]).

When such an inflection section BS is included in the travel route Rt, the setting unit 31 may set, as the movement completion point EP, a point before the inflection section BS when viewed from the start point Ps of the travel route Rt.

As an example, the setting unit 31 may set, as the movement completion point EP, a point P1 that is a point before (for example, 1 [m] to 2 [m] before) the inflection section BS1 when viewed from the start point Ps. Here, the inflection section BS1 is an inflection section BS closest to the current position CP of the vehicle 1 (in other words, the end point Pe of the travel route Rt) among the inflection sections BS included in the travel route Rt. The inflection section BS1 may be an inflection section BS within a predetermined range from the current position CP among the inflection sections BS included in the travel route Rt. The predetermined range may be, for example, a range within a predetermined distance from the current position CP along the travel route Rt. The predetermined distance is a distance shorter than an upper limit (for example, 200 [m]) of the travel route Rt indicated by the travel route information contained in the travel history information 200, and can be, for example, a distance determined in advance by a manufacturer of the vehicle 1.

When the point P1 is set as the movement completion point EP, the travel control unit 32 may cause the vehicle 1 to move (for example, reverse) along the travel route Rt from the current position CP to the point P1, which is the movement completion point EP, as indicated by an arrow α in FIG. 3. Accordingly, the vehicle 1 can return from the third road R3 to the second road R2.

In this way, when the inflection section BS is included in the travel route Rt, by setting, as the movement completion point EP, a point before the inflection section BS when viewed from the start point Ps of the travel route Rt, reverse assist travel for returning the vehicle 1 to the point before the inflection section BS can be performed. Therefore, it is possible to improve the convenience of the user who wants to leave the inflection section BS without taking time and effort.

When a plurality of inflection sections BS are included in the travel route Rt, the setting unit 31 may set, as the movement completion point EP, a point (for example, the point P1 shown in FIG. 3) before an inflection section BS closest to the current position CP (for example, the inflection section BS1 shown in FIG. 3) among the plurality of inflection sections BS. In this way, as compared with a case where a point (for example, a point P2 shown in FIG. 3) before another inflection section BS (for example, the inflection section BS2 shown in FIG. 3) is set as the movement completion point EP, it is possible to prevent the vehicle 1 from moving too far away from the current position CP by the reverse assist travel.

A method of detecting the inflection section BS is not particularly limited. As an example, the control device 30 may acquire a rotation amount of each of the left and right rear wheels of the vehicle 1, performs a calculation of calculating a movement position and a yaw angle of the vehicle 1 based on a change amount of the rotation amount, and detect the inflection section BS on a condition that the yaw angle is changed by a predetermined angle (for example, 90 degrees) while the vehicle 1 moves by a predetermined distance. As another example, the inflection section BS can be detected based on a direction of the vehicle 1 recognized by the navigation device 20, or the inflection section BS can be detected by tracking a change in the front image and performing image processing.

For example, the travel route Rt may include a specific section SR that is a section including any of an intersection, a railroad crossing, and a temporary stop. Here, the temporary stop is a place defined by regulations or the like for a temporary stop.

When such a specific section SR is included in the travel route Rt, the setting unit 31 may exclude a point within the specific section SR from candidates for the movement completion point EP and set a point outside the specific section SR as the movement completion point EP.

In the example shown in FIG. 3, an inflection section BS2 in the travel route Rt, which is a portion included in the intersection CS (specifically, a hatched region in FIG. 3), corresponds to the specific section SR. Therefore, in this case, the setting unit 31 may exclude points included in the inflection section BS2, which is the specific section SR, among points on the travel route Rt from the candidates for the movement completion point EP, and set a point outside the inflection section BS2 as the movement completion point EP. In this case, the setting unit 31 may set, as the movement completion point EP, the point P2 before the inflection section BS2 (that is, the specific section SR) when viewed from the start point Ps.

When the specific section SR is included in the travel route Rt as described above, by setting a point outside the specific section SR as the movement completion point EP, reverse assist travel to the movement completion point EP that is not appropriate for stopping the vehicle 1 from a viewpoint of traffic safety can be prevented from being performed.

Further, as long as a point before the specific section SR when viewed from the start point Ps is set as the movement completion point EP, reverse assist travel for returning the vehicle 1 to the point before the specific section SR can be performed. Therefore, in this way, reverse assist travel for returning the vehicle 1 to a point suitable for the user to drive the vehicle 1 again can be performed, and the convenience of the user can be improved.

### Second Example of Movement Completion Point

For example, when the vehicle 1 enters a narrow road, a section in which a road width is less than a predetermined value (hereinafter, also referred to as “road width decreased section WR”) may be included in the travel route Rt. When such a road width decreased section WR is included in the travel route Rt, the setting unit 31 may set, as the movement completion point EP, a point before the road width decreased section WR when viewed from the start point Ps.

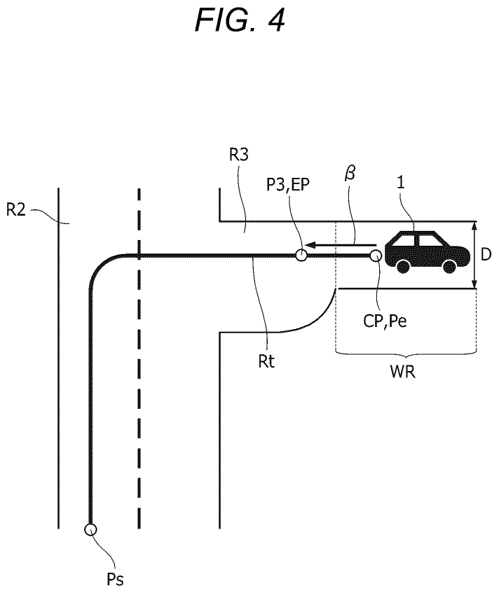

For example, it is assumed that the vehicle 1 enters the road width decreased section WR of the third road R3, as shown in FIG. 4. Here, the road width decreased section WR is a section in which a road width D is less than a predetermined value (for example, 3.5 [m]). In this case, the setting unit 31 may set, as the movement completion point EP, a point P3 which is a point before the road width decreased section WR when viewed from the start point Ps.

When the point P3 is set as the movement completion point EP, the travel control unit 32 may cause the vehicle 1 to move (for example, reverse) along the travel route Rt from the current position CP to the point P3, which is the movement completion point EP, as indicated by an arrow β in FIG. 4. Accordingly, the vehicle 1 can leave the road width decreased section WR by the reverse assist travel. Then, at the point P3 having a sufficient road width, the user can reverse the direction of the vehicle 1 by making a U-turn, turning back, or the like to return the vehicle 1 to the second road R2.

In this way, when the road width decreased section WR is included in the travel route Rt, by setting a point before the road width decreased section WR when viewed from the start point Ps of the travel route Rt as the movement completion point EP, reverse assist travel for returning the vehicle 1 to a point before the road width decreased section WR can be performed. Therefore, it is possible to improve the convenience of the user who wants to leave the road width decreased section WR without taking time and effort.

### Third Example of Movement Completion Point

Both the inflection section BS and the road width decreased section WR may be included in the travel route Rt. Therefore, when the inflection section BS and the road width decreased section WR are included in the travel route Rt, the setting unit 31 may set, as the movement completion point EP, a point before the road width decreased section WR when viewed from the start point Ps. That is, when both the inflection section BS and the road width decreased section WR are included in the travel route Rt, the setting unit 31 may set the movement completion point EP by preferentially using the road width decreased section WR over the inflection section BS.

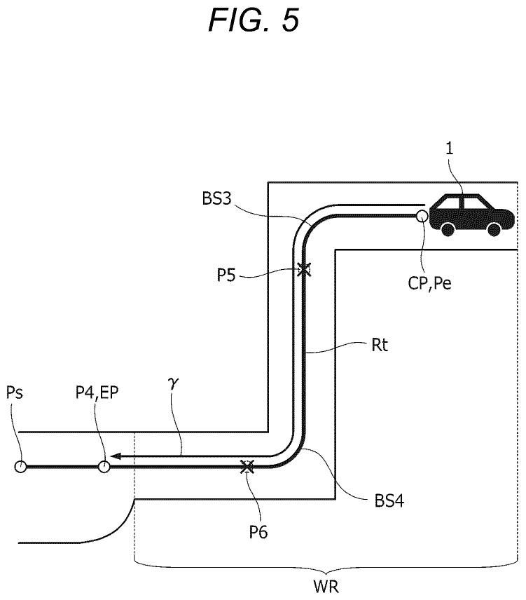

For example, it is assumed that an inflection section BS3 and an inflection section BS4 as the inflection sections BS and the road width decreased section WR are included in the travel route Rt, as shown in FIG. 5. In this case, for example, the setting unit 31 sets, as the movement completion point EP, a point P4 which is a point before the road width decreased section WR when viewed from the start point Ps. In other words, in this case, the setting unit 31 does not set a point P5 that is a point before the inflection section BS3 or a point P6 that is a point before the inflection section BS4 when viewed from the start point Ps, as the movement completion point EP.

When the point P4 is set as the movement completion point EP, as indicated by an arrow γ in FIG. 5, the travel control unit 32 may cause the vehicle 1 to move (for example, reverse) from the current position CP to the point P4 which is the movement completion point EP, along the travel route Rt. Accordingly, even if both the inflection section BS and the road width decreased section WR are included in the travel route Rt, the vehicle 1 can leave the road width decreased section WR by the reverse assist travel.

When the inflection section BS and the road width decreased section WR are included in the travel route Rt as described above, by setting the movement completion point EP preferentially using the road width decreased section WR over the inflection section BS, reverse assist travel for returning the vehicle 1 to an appropriate movement completion point EP can be performed, and the convenience of the user is improved.

### Fourth Example of Movement Completion Point

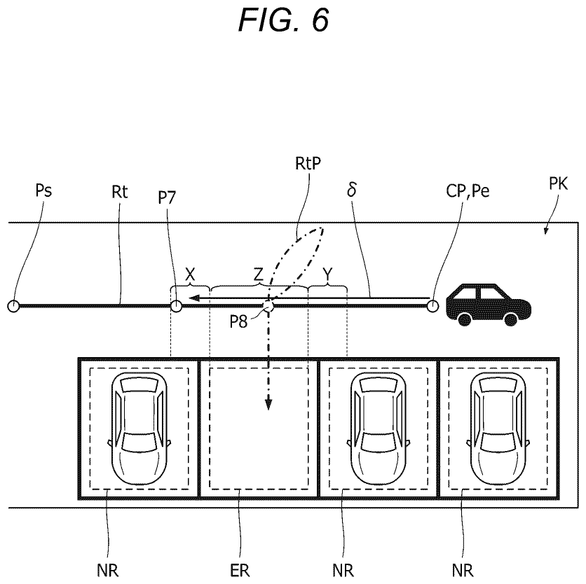

In an example shown in FIG. 6, the vehicle 1 enters a parking lot PK. In the parking lot PK, there are an available parking region ER where the vehicle 1 can be parked and unavailable parking regions NR where the vehicle 1 cannot be parked. Here, the available parking region ER is, for example, a parking space (that is, an empty parking space) in which another vehicle is not parked among parking spaces partitioned by white lines or the like. The unavailable parking region NR is, for example, a parking space in which another vehicle is parked among the parking spaces. For example, the control device 30 can detect each of the available parking region ER and the unavailable parking region NR present in the periphery of the vehicle 1, based on the external environment information acquired via the external environment sensor 11.

When such an available parking region ER is present adjacent to the travel route Rt, the setting unit 31 may set, as the movement completion point EP, a point included in a predetermined range defined with reference to the available parking region ER.

As an example, the setting unit 31 may set a point P7 included in a predetermined range X shown in FIG. 6 as the movement completion point EP. Here, the predetermined range X is a predetermined range before the available parking region ER when viewed from the start point Ps.

When the point P7 is set as the movement completion point EP, as indicated by an arrow δ in FIG. 6, the travel control unit 32 may cause the vehicle 1 to move (for example, reverse) from the current position CP to the point P7, which is the movement completion point EP, along the travel route Rt. Accordingly, by the reverse assist travel, the vehicle 1 can be returned to the point P7 where the user easily start parking in the available parking region ER. In this way, after that, the user can park the vehicle 1 in the available parking region ER by moving the vehicle 1 forward from the point P7 to a point P8 and moving the vehicle 1 along a parking route RtP from the point P8.

Instead of the above, the setting unit 31 may set a point included in a predetermined range Y shown in FIG. 6 as the movement completion point EP. Here, the predetermined range Y is a predetermined range closer to the current position CP than the available parking region ER.

As still another example, the setting unit 31 may set, as the movement completion point EP, a point having a shortest distance to the available parking region ER among points on the travel route Rt. In the example shown in FIG. 6, among the points on the travel route Rt, a point included in a range Z is the point having the shortest distance to the available parking region ER. Therefore, in this case, the setting unit 31 may set a point included in the range Z (for example, the point P8 shown in FIG. 6) as the movement completion point EP.

In this way, when the available parking region ER is present adjacent to the travel route Rt, by setting, as the movement completion point EP, a point included in a predetermined range defined with reference to the available parking region ER among the points on the travel route Rt or a point having the shortest distance to the available parking region ER among the points on the travel route Rt, reverse assist travel for returning the vehicle 1 to a point near the available parking region ER can be performed. Accordingly, the convenience of the user who wants to park in the available parking region ER is improved.

A plurality of available parking regions ER may be present adjacent to the travel route Rt. As described above, when a plurality of available parking regions ER are present adjacent to the travel route Rt, the setting unit 31 may set, as the movement completion point EP, a point included in a predetermined range defined with reference to an available parking region ER closest to the current position among the plurality of available parking regions ER, for example. Alternatively, the setting unit 31 may set, as the movement completion point EP, a point included in a predetermined range defined with reference to an available parking region ER designated by the user among the plurality of available parking regions ER.

In this way, by setting, as the movement completion point EP, a point included in a predetermined range defined with reference to an available parking region ER closest to the current position or an available parking region ER designated by the user among the plurality of available parking regions ER, reverse assist travel for returning the vehicle 1 to a point near the available parking region ER desired by the user can be performed, and the convenience of the user is improved.

The control device 30 may be configured to, when the available parking region ER is present adjacent to the travel route Rt, derive the parking route RtP for parking the vehicle 1 in the available parking region ER. As an example, the control device 30 is configured to, when the control device 30 has a parking assistance function of assisting a steering operation of the user during parking, derive the parking route RtP by using the parking assistance function.

When the control device 30 can derive the parking route RtP, the setting unit 31 may set, as the movement completion point EP, a point included in a predetermined range defined with reference to a connection point between the parking route RtP derived by the control device 30 and the travel route Rt.

For example, in the example shown in FIG. 6, the point P8 is the connection point between the parking route RtP and the travel route Rt. Therefore, in this case, a point included in a predetermined range from the point P8 toward the start point Ps or a predetermined range from the point P8 toward the current position CP among the points on the travel route Rt may be set as the movement completion point EP. In this way, reverse assist travel for returning the vehicle 1 to a point at which parking in the available parking region ER is considered to be easy can be performed, and the convenience of the user is improved.

### Fifth Example of Movement Completion Point

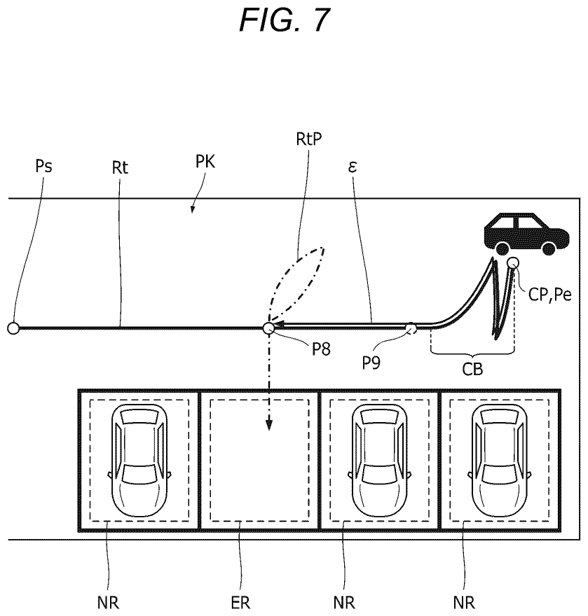

An example shown in FIG. 7 is different from the example shown in FIG. 6 in that a turning section CB is included in the travel route Rt. Here, the turning section CB is a section in which the vehicle 1 is turned once or more. The turning section CB may be a section in which turning is performed a plurality of times or more while the vehicle 1 travels a predetermined distance.

When such a turning section CB is included in the travel route Rt, the setting unit 31 may set, as the movement completion point EP, a point before the turning section CB when viewed from the start point Ps. As an example, in this case, the setting unit 31 may set the point P8 described above as the movement completion point EP. As another example, in this case, the setting unit 31 may set, as the movement completion point EP, a point P9 immediately before the turning section CB when viewed from the start point Ps.

When the point P8 is set as the movement completion point EP, as indicated by an arrow ε in FIG. 7, the travel control unit 32 may cause the vehicle 1 to move (for example, reverse) from the current position CP to the point P8, which is the movement completion point EP, along the travel route Rt.

In this way, when the turning section CB is included in the travel route Rt, by setting a point before the turning section CB when viewed from the start point Ps as the movement completion point EP, reverse assist travel for returning the vehicle 1 to the point before the turning section CB can be performed. Therefore, it is possible to improve the convenience of the user who wants to leave the turning section CB without taking time and effort.

A method of detecting the turning section CB is not particularly limited. As an example, the control device 30 can detect the turning section CB, for example, by making it possible to specify a point (position of the vehicle 1) where an operation of swinging a front end of the vehicle 1 (for example, |steering angle θst|>90 degrees) is performed from a state of straight travel (for example, the steering angle θst is within ±20 degrees). The control device 30 may detect the turning section CB based on a position of the vehicle 1 at the time of shift switching from “R” to “D” or from “D” to “R” (that is, shift switching for reversing a travel direction of the vehicle 1) while referring the travel history information 200.

### 2-3. Processing Performed by Control Device

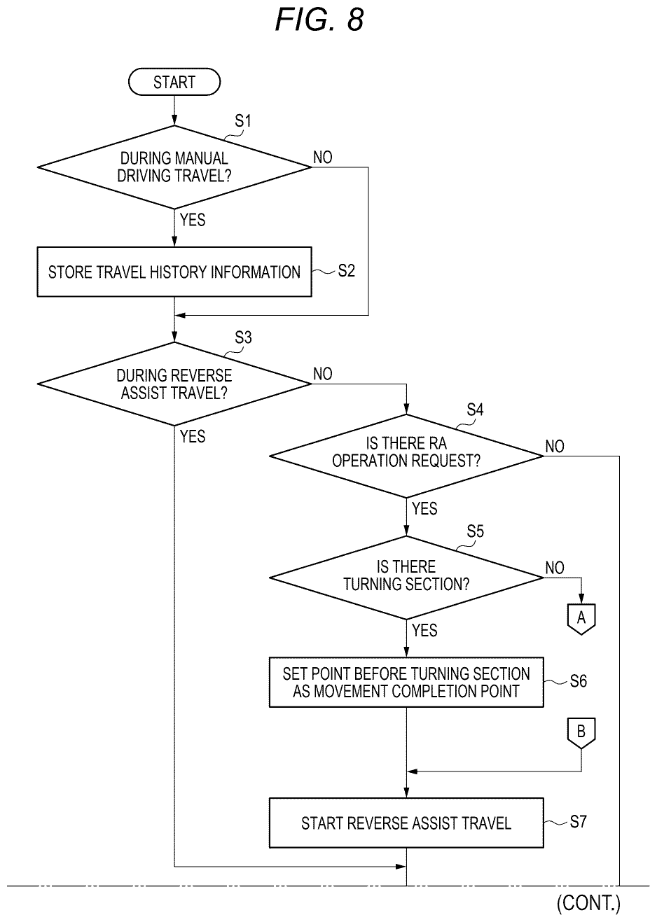

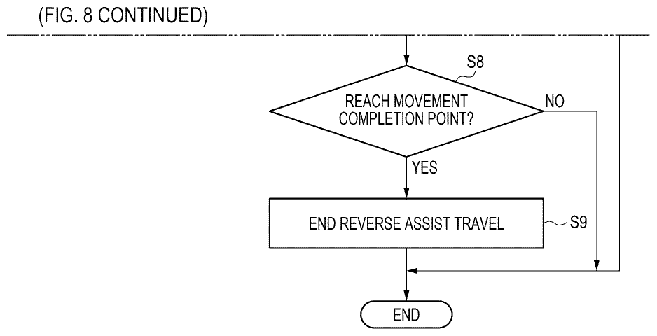

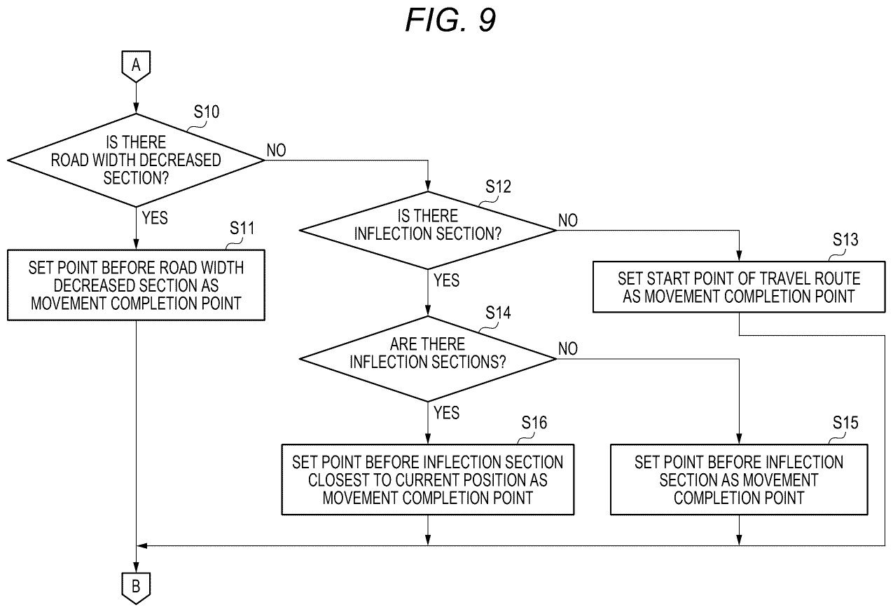

Next, an example of processing performed by the control device 30 will be described with reference to FIGS. 8 and 9. For example, when an ignition power supply of the vehicle 1 is turned on, the control device 30 repeatedly performs a series of processing shown in FIGS. 8 and 9 at a predetermined cycle.

As shown in FIG. 8, for example, the control device 30 first determines whether the vehicle 1 is in the manual driving travel (step S1). When it is determined that the manual driving travel is not being performed (step S1: NO), the control device 30 proceeds to processing in step S3. When it is determined that the manual driving travel is being performed (step S1: YES), the control device 30 stores the travel history information 200 in the storage unit 35 based on the information obtained by the sensor group 10 or the like (step S2), and proceeds to the processing in step S3.

Next, the control device 30 determines whether the vehicle 1 is in the reverse assist travel (step S3). When it is determined that the reverse assist travel is being performed (step S3: YES), the control device 30 proceeds to processing in step S8. When it is determined that the reverse assist travel is not being performed (step S3: NO), the control device 30 determines whether there is an RA operation request (step S4).

When it is determined that there is no RA operation request (step S4: NO), the control device 30 ends the series of processing. On the other hand, when it is determined that there is an RA operation request (step S4: YES), the control device 30 determines whether the turning section CB is included in the travel route Rt based on the travel history information 200 stored in the storage unit 35 (step S5).

When it is determined that the turning section CB is included in the travel route Rt (step S5: YES), the control device 30 sets, as the movement completion point EP, a point before the turning section CB when viewed from the start point Ps, as shown in FIG. 7 (step S6).

Then, the control device 30 starts the reverse assist travel from the current position of the vehicle 1 to the set movement completion point EP based on the travel history information 200 stored in the storage unit 35 (step S7).

Next, the control device 30 determines whether the vehicle 1 reaches the movement completion point EP (step S8). When it is determined that the vehicle 1 does not reach the movement completion point EP (step S8: NO), the control device 30 ends the series of processing.

When it is determined that the vehicle 1 reaches the movement completion point EP (step S8: YES), the control device 30 ends the reverse assist travel (step S9) and ends the series of processing. When the reverse assist travel is ended, the control device 30 may notify the user that the reverse assist travel is completed. As an example, the control device 30 may notify the user that the reverse assist travel is completed, by displaying a message such as “the reverse assist is completed” on the touch panel 22.

When it is determined in the processing in step S5 that the turning section CB is not included in the travel route Rt (step S5: NO), the control device 30 proceeds to processing in step S10 shown in FIG. 9, and determines whether the road width decreased section WR is included in the travel route Rt (step S10).

When it is determined that the road width decreased section WR is included in the travel route Rt (step S10: YES), as shown in FIGS. 4 and 5, the control device 30 sets, as the movement completion point EP, a point before the road width decreased section WR when viewed from the start point Ps (step S11), and proceeds to the processing in step S7.

When it is determined that the road width decreased section WR is not included in the travel route Rt (step S10: NO), the control device 30 determines whether the inflection section BS is included in the travel route Rt (step S12). When it is determined that the inflection section BS is not included in the travel route Rt (step S12: NO), the control device 30 sets the start point Ps of the travel route Rt as the movement completion point EP (step S13), and proceeds to the processing in step S7.

When it is determined that the inflection section BS is included in the travel route Rt (step S12: YES), the control device 30 determines whether a plurality of inflection sections BS are included in the travel route Rt (step S14). When it is determined that a plurality of inflection sections BS are not included in the travel route Rt (step S14: NO), that is, when it is determined that one inflection section BS is included in the travel route Rt, the control device 30 sets, as the movement completion point EP, a point before the inflection section BS when viewed from the start point Ps (step S15), and proceeds to the processing in step S7.

When it is determined that a plurality of inflection sections BS are included in the travel route Rt (step S14: YES), the control device 30 sets, as the movement completion point EP, a point before the start point Ps of an inflection section BS closest to the current position of the vehicle 1 among the plurality of inflection sections BS (step S16), and proceeds to the processing in step S7.

As described above, according to the control device 30 of the present embodiment, since the movement completion point EP during the reverse assist travel of the vehicle 1 can be automatically set, the time and effort for the user to set the movement completion point EP is reduced, and the convenience of the user can be improved. Further, it is possible to improve traffic safety and contribute to development of a sustainable transportation system.

Further, according to the control device 30, since a point that may be desired by the user as the movement completion point EP can be automatically set as the movement completion point EP, it is possible to perform reverse assist travel desired by the user while reducing the time and effort for the user to set the movement completion point EP.

Although various embodiments have been described above with reference to the drawings, it is needless to say that the present disclosure is not limited to these examples. It is apparent to those skilled in the art that various changes or modifications can be conceived within the scope described in the claims, and it is understood that the changes or modifications naturally fall within the technical scope of the present disclosure. In addition, the constituent elements in the above embodiment may be freely combined without departing from the gist of the disclosure.

The control method described in the above embodiment may be implemented by executing a program (control program) prepared in advance on a computer. For example, the present program is stored in a computer-readable storage medium and executed by being read from the storage medium. In addition, the present program may be provided in a form of being stored in a nonvolatile (non-transitory) storage medium such as a flash memory, or may be provided via a network such as the Internet.

In the embodiment described above, the computer that executes the program is the control device 30 provided in the vehicle 1, but the present disclosure is not limited thereto. For example, the computer that executes the present program may be provided in another device (for example, the external device 2) capable of communicating with the control device 30.

In the present description, at least the following matters are described. In the parentheses, the corresponding constituent elements and the like in the above embodiment are shown as examples, but the present disclosure is not limited thereto.
(1) A control device (control device 30) for controlling a vehicle (vehicle 1), including:
a travel control unit (travel control unit 32) configured to perform, based on travel history information (travel history information 200) including travel route information indicating a travel route during first travel to a current position (current position CP) of the vehicle, second travel for causing the vehicle to move along the travel route from the current position to a movement completion point (movement control point EP) on the travel route, the travel history information being stored in a storage unit (storage unit 35); and
a setting unit (setting unit 31) configured to set, before the second travel, a point on the travel route satisfying a predetermined condition as the movement completion point, in which
the travel control unit performs the second travel to the movement completion point set by the setting unit, and ends the second travel in response to the vehicle reaching the movement completion point.

According to (1), since the movement completion point during the second travel of the vehicle can be automatically set, time and effort for a user to set the movement completion point is reduced, and convenience of the user can be improved. Further, it is possible to improve traffic safety and contribute to development of a sustainable transportation system.
(2) The control device according to (1), in which,
in response to an inflection section (inflection section BS) in which a direction of the vehicle is changed by a predetermined angle or more being included in the travel route, the setting unit sets, as the movement completion point, a point before the inflection section when viewed from a start point (start point Ps) of the travel route opposite to the current position.

According to (2), since a point before the inflection section when viewed from the start point of the travel route is set as the movement completion point, the second travel for returning the vehicle to the point before the inflection section can be performed. Therefore, it is possible to improve the convenience of the user who wants to leave the inflection section without taking time and effort.
(3) The control device according to (2), in which
in response to a plurality of the inflection sections being included in the travel route, the setting unit sets, as the movement completion point, a point before an inflection section closest to the current position among the plurality of inflection sections.

According to (3), since a point before the inflection section closest to the current position of the vehicle is set as the movement completion point, as compared with a case where a point before another inflection section is set as the movement completion point, it is possible to prevent the vehicle from moving too far away from the current position by the second travel.
(4) The control device according to (1), in which,
in response to a specific section (specific section SR) including any one of a railroad crossing, an intersection, or a temporary stop being included in the travel route, the setting unit sets a point outside the specific section as the movement completion point.

According to (4), since a point outside the specific section is set as the movement completion point of the second travel, the vehicle can be prevented from being stopped at a point that is not appropriate from a viewpoint of traffic safety when the second travel ends.
(5) The control device according to (4), in which
the setting unit sets, as the movement completion point, a point before the specific section when viewed from a start point (start point Ps) of the travel route opposite to the current position.

According to (5), since a point before the specific section when viewed from the start point of the travel route is set as the movement completion point, the second travel for returning the vehicle to the point before the specific section can be performed. Therefore, the second travel for returning the vehicle to a point suitable for the user of the vehicle to drive again can be performed, and the convenience for the user can be improved.
(6) The control device according to (1), in which,
in response to a road width decreased section (road width decreased section WR) having a road width less than a predetermined value being included in the travel route, the setting unit sets, as the movement completion point, a point before the road width decreased section when viewed from a start point (start point Ps) of the travel route opposite to the current position.

According to (6), since a point before the road width decreased section when viewed from the start point of the travel route is set as the movement completion point, the second travel for returning the vehicle to the point before the road width decreased section can be performed. Therefore, it is possible to improve the convenience of the user who wants to leave the road width decreased section without taking time and effort.
(7) The control device according to (1), in which,
in response to an inflection section (inflection section BS) in which a direction of the vehicle is changed by a predetermined angle or more and a road width decreased section (road width decreased section WR) having a road width less than a predetermined value being included in the travel route, the setting unit sets, as the movement completion point, a point before the road width decreased section when viewed from a start point (start point Ps) of the travel route opposite to the current position.

According to (7), even if the inflection section and the road width decreased section are included in the travel route, the second travel for returning the vehicle to an appropriate movement completion point can be performed, and thus the convenience for the user is improved.
(8) The control device according to (1), in which,
in response to at least one available parking region (available parking region ER) in which the vehicle is able to be parked being present adjacent to the travel route, the setting unit sets, as the movement completion point, a point included in a predetermined range defined with reference to the available parking region among points on the travel route or a point having a shortest distance to the at least one available parking region among the points on the travel route.

According to (8), since the second travel for returning the vehicle to a point near the available parking region can be performed, the convenience of the user who wants to park in the available parking region is improved.
(9) The control device according to (8), in which,
the at least one available parking region includes a plurality of available parking regions,
in response to the plurality of available parking regions being present adjacent to the travel route, the setting unit sets, as the movement completion point, a point included in the predetermined range defined with reference to one available parking region among the plurality of available parking regions, or a point having a shortest distance to the one available parking region among the points on the travel route, and
the one available parking region is an available parking region closest to the current position among the plurality of available parking regions, or an available parking region designated by a user of the vehicle among the plurality of available parking regions.

According to (9), since the second travel for returning the vehicle to a point near the available parking region desired by the user can be performed, the convenience of the user who wants to park in the available parking region is improved.
(10) The control device according to (8), in which
in response to the at least one available parking region (available parking region ER) in which the vehicle is able to be parked being present adjacent to the travel route (travel route RtP), the control device derives a parking route for parking the vehicle in the at least one available parking region, and,
in response to the at least one available parking region in which the vehicle is able to be parked being present adjacent to the travel route, the setting unit sets, as the movement completion point, a point included in the predetermined range defined with reference to a connection point between the parking route and the travel route.

According to (10), since the second travel for returning the vehicle to a point where it is considered to be easy to park in the available parking region can be performed, the convenience of the user who wants to park in the available parking region is improved.
(11) The control device according to (1), in which,
in response to a turning section (turning section CB) in which the vehicle is turned once or more being included in the travel route, the setting unit sets, as the movement completion point, a point before the turning section when viewed from a start point (start point Ps) of the travel route opposite to the current position.

According to (11), since a point before the turning section when viewed from the start point of the travel route is set as the movement completion point, the second travel for returning the vehicle to the point before the turning section can be performed. Therefore, it is possible to improve the convenience of the user who wants to leave the turning section without taking time and effort.
(12) A control method including:
performing (step S7 to S9), by a computer (control device 30) that controls a vehicle (vehicle 1), based on travel history information (travel history information 200) including travel route information indicating a travel route (travel route Rt) during first travel to a current position (current position 30) of the vehicle, second travel for causing the vehicle to move along the travel route from the current position to a movement completion point (movement completion point EP) on the travel route, the travel history information being stored in a storage unit (storage unit 35); and
   setting (step S6, S11, S13, S15, S16), by the computer, before the second travel, a point on the travel route satisfying a predetermined condition as the movement completion point, in which
   in the processing of causing the vehicle to move along the travel route, the second travel to the set movement completion point is performed, and the second travel is ended in response to the vehicle reaching the movement completion point.

According to (12), since the movement completion point during the second travel of the vehicle can be automatically set, the time and effort for the user to set the movement completion point is reduced, and the convenience of the user can be improved. Further, it is possible to improve the traffic safety and contribute to the development of the sustainable transportation system.
(13) A non-transitory computer-readable storage medium storing a control program causing a computer (control device 30) that controls a vehicle (vehicle 1) to perform a process including:
performing (step S7 to S9), based on travel history information (travel history information 200) including travel route information indicating a travel route (travel route Rt) during first travel to a current position (current position CP) of the vehicle, second travel for causing the vehicle to move along the travel route from the current position to a movement completion point (movement completion point EP) on the travel route, the travel history information being stored in a storage unit (storage unit 35); and
setting (step S6, S11, S13, S15, S16), before the second travel, a point on the travel route satisfying a predetermined condition as the movement completion point, in which
in the causing of the vehicle to move along the travel route, the second travel to the set movement completion point is performed, and the second travel is ended in response to the vehicle reaching the movement completion point.

According to (13), since the movement completion point during the second travel of the vehicle can be automatically set, the time and effort for the user to set the movement completion point is reduced, and the convenience of the user can be improved. Further, it is possible to improve the traffic safety and contribute to the development of the sustainable transportation system.

What is claimed is:

1. A control device for controlling a vehicle, comprising:
a travel control unit configured to perform, based on travel history information including travel route information indicating a travel route during first travel to a current position of the vehicle, second travel for causing the vehicle to move along the travel route from the current position to a movement completion point on the travel route, the travel history information being stored in a storage unit; and
a setting unit configured to set, before the second travel, a point on the travel route satisfying a predetermined condition as the movement completion point, wherein
the travel control unit performs the second travel to the movement completion point set by the setting unit, and ends the second travel in response to the vehicle reaching the movement completion point.

2. The control device according to claim 1, wherein,
in response to an inflection section in which a direction of the vehicle is changed by a predetermined angle or more being included in the travel route, the setting unit sets, as the movement completion point, a point before the inflection section when viewed from a start point of the travel route opposite to the current position.

3. The control device according to claim 2, wherein,
in response to a plurality of the inflection sections being included in the travel route, the setting unit sets, as the movement completion point, a point before an inflection section closest to the current position among the plurality of inflection sections.

4. The control device according to claim 1, wherein,
in response to a specific section including any one of a railroad crossing, an intersection, or a temporary stop being included in the travel route, the setting unit sets a point outside the specific section as the movement completion point.

5. The control device according to claim 4, wherein
the setting unit sets, as the movement completion point, a point before the specific section when viewed from a start point of the travel route opposite to the current position.

6. The control device according to claim 1, wherein,
in response to a road width decreased section having a road width less than a predetermined value being included in the travel route, the setting unit sets, as the movement completion point, a point before the road width decreased section when viewed from a start point of the travel route opposite to the current position.

7. The control device according to claim 1, wherein,
in response to an inflection section in which a direction of the vehicle is changed by a predetermined angle or more and a road width decreased section having a road width less than a predetermined value being included in the travel route, the setting unit sets, as the movement completion point, a point before the road width decreased section when viewed from a start point of the travel route opposite to the current position.

8. The control device according to claim 1, wherein,
in response to at least one available parking region in which the vehicle is able to be parked being present adjacent to the travel route, the setting unit sets, as the movement completion point, a point included in a predetermined range defined with reference to the available parking region among points on the travel route or a point having a shortest distance to the at least one available parking region among the points on the travel route.

9. The control device according to claim 8, wherein,
the at least one available parking region includes a plurality of available parking regions,
in response to the plurality of available parking regions being present adjacent to the travel route, the setting unit sets, as the movement completion point, a point included in the predetermined range defined with reference to one available parking region among the plurality of available parking regions, or a point having a shortest distance to the one available parking region among the points on the travel route, and
the one available parking region is an available parking region closest to the current position among the plurality of available parking regions, or an available parking region designated by a user of the vehicle among the plurality of available parking regions.

10. The control device according to claim 8, wherein
in response to the at least one available parking region in which the vehicle is able to be parked being present adjacent to the travel route, the control device derives a parking route for parking the vehicle in the at least one available parking region, and,
in response to the at least one available parking region in which the vehicle is able to be parked being present adjacent to the travel route, the setting unit sets, as the movement completion point, a point included in the predetermined range defined with reference to a connection point between the parking route and the travel route.

11. The control device according to claim 1, wherein,
in response to a turning section in which the vehicle is turned once or more being included in the travel route, the setting unit sets, as the movement completion point, a point before the turning section when viewed from a start point of the travel route opposite to the current position.

12. A control method comprising:
performing, by a computer that controls a vehicle, based on travel history information including travel route information indicating a travel route during first travel to a current position of the vehicle, second travel for causing the vehicle to move along the travel route from the current position to a movement completion point on the travel route, the travel history information being stored in a storage unit; and
setting, by the computer, before the second travel, a point on the travel route satisfying a predetermined condition as the movement completion point, wherein
in the processing of causing the vehicle to move along the travel route, the second travel to the set movement completion point is performed, and the second travel is ended in response to the vehicle reaching the movement completion point.

13. A non-transitory computer-readable storage medium storing a control program causing a computer that controls a vehicle to perform a process comprising:
performing, based on travel history information including travel route information indicating a travel route during first travel to a current position of the vehicle, second travel for causing the vehicle to move along the travel route from the current position to a movement completion point on the travel route, the travel history information being stored in a storage unit; and
setting, before the second travel, a point on the travel route satisfying a predetermined condition as the movement completion point, wherein
in the causing of the vehicle to move along the travel route, the second travel to the set movement completion point is performed, and the second travel is ended in response to the vehicle reaching the movement completion point.
